(19) United States
(12) Patent Application Publication
(10) Pub. No.: US 2026/0339875 A1
(43) Pub. Date: Oct. 29, 2026

(54) METHOD AND DEVICES FOR SELECTION OF INPUT/OUTPUT DEVICES IN A WIRELESS COMMUNICATION SYSTEM

(71) Applicant: Telefonaktiebolaget LM Ericsson (publ), Stockholm (SE)

(72) Inventors: Niklas LINDSKOG, LUND (SE); Peter ÖKVIST, LULEÅ (SE); Tommy ARNGREN, SÖDRA SUNDERBYN (SE); Patrik SALMELA, ESPOO (FI)

(21) Appl. No.: 19/115,338

(22) PCT Filed: Oct. 31, 2022
(86) PCT No.: PCT/EP2022/080344

§ 371 Date: Mar. 26, 2025

(51) Int. Cl. G06F 13/42; H04W 76/20

(52) U.S. Cl. CPC G06F 13/42; H04W 76/20

(57) ABSTRACT

Methods are provided for enabling adaptation of connectivity of the User Tag during an ongoing communication session provided to the User tag by a service via a set of at least one input/output device, wherein a preceding beacon signal, detectable by the at least one IOD when the UT is located in close vicinity of the at least one IOD, is transmitted. Some methods include modifying the preceding beacon signal, upon determining that an adaptation of the set of at least one IOD is required, wherein the modification comprises including an indication to the beacon signal, indicating a request for an adaptation of the set of at least one IOD, and transmitting the modified beacon signal, thereby enabling one or more IODs, located in close vicinity of the UT, to participate in an adaptation of the set of the at least one IOD.

### TECHNICAL FIELD

The present disclosure relates to selection of input/output devices (IODs) during an ongoing communication session, accessed through a User Tag (UT).

### BACKGROUND

There are different solutions that enable access, sharing and use of hardware resources, available in a certain context, room or network, such as e.g. Apple-TV, Sun stateless terminals or video conferencing systems. However, all these solutions have in common that the users in some ways are logged onto the corresponding communication system and which communication devices the communication system at hand holds are defined by the system itself.

Current solution for switching, adding or removing Input/Output devices (IODs) in a cloud computing context, as described in EP 3912312, are focusing on maintaining the capabilities of the IODs throughout a communication session.

Advancements in operational features have also required more highly integrated and faster processing circuits with greater circuit densities, which becomes more difficult under constraints on costs and power consumption.

This all-inclusive feature-rich approach for user terminal development does not satisfy all of the myriad of differing desires held by consumers seeking solutions for the rapidly expanding variety of communication services. Moreover, the always-connected expectations of today's society obligate users to vigilantly keep their communication devices within reach or risk being unable to timely receive or initiate communication services. A more dynamic approach with respect to accessibility is therefore required.

### SUMMARY

It is an object of the present disclosure to, at least partly, address the aspects mentioned above.

More specifically, according to one aspect, a method in a User Tag, UT, for enabling adaptation of connectivity of the UT during an ongoing communication session is suggested, wherein the method comprise: transmitting a preceding beacon signal during the ongoing communication session during the ongoing communication session, wherein the preceding beacon signal is detectable by at least one Input/Output Device, IOD, when the UT is located in close vicinity of the at least one IOD; modifying the preceding beacon signal, upon determining that an adaptation of the set of at least one IOD is required, wherein the modification comprises including an indication to the beacon signal, indicating a request for an adaptation of the set of at least one IOD, and transmitting the modified beacon signal, thereby enabling one or more IODs, located in close vicinity of the UT, to participate in an adaptation of the set of the at least one IOD.

According to another aspect, a method in an Input/Output Device Handler, IODH, for adapting connectivity of a User Tag, UT, during an ongoing communication session, is suggested, wherein the method comprise: receiving, first information from a first set of at least one Input/Output Device, IOD, in a respective beacon signal, associated with the ongoing communication session and received by the respective one or more IOD from the UT; determining an adaptation of the first set of at least one IOD, based on second information, comprised in one or more modified beacon signals, received from a second set of at least one IOD, and instructing one or more of the at least one IOD on how to participate in the adaptation of the first set of at least one IOD, based on the determined adaptation.

According to yet another aspect, a method in a first Input/Output Device, IOD, for contributing when adapting connectivity during an ongoing communication session, is suggested, where the method comprise: receiving a beacon signal, associated with the ongoing communication session and transmitted by a User Tag, UT; determining, based, at least partly, on content of the received beacon signal, indicating whether the received beacon signal is a modified beacon signal or not, if the received beacon signal is to be forwarded to an Input/Output Device Handler, IODH, or refrained from forwarding, and forwarding, to the IODH, at least part of the content of the received beacon signal, thereby enabling the IODH to determine how the first IOD is to act during the adaptation of the set of at least one IOD, in case it is determined that the received beacon signal is a modified beacon signal and that the at least part of the content is to be forwarded.

According to another aspect, a User Tag, UT, for enabling adaptation of connectivity of the UT during an ongoing communication session is suggested, where the UT comprise processing circuitry configured to cause the UT to: transmit a preceding beacon signal, during the ongoing communication session, wherein the preceding beacon signal is detectable by the at least one Input/Output Device, IOD, when the UT is located in close vicinity of the at least one IOD; modify the preceding beacon signal, upon determining that an adaptation of the set of at least one IOD is required, wherein the modification comprises including an indication to the beacon signal, indicating a request for an adaptation of the set of at least one IOD, and transmit the modified beacon signal, thereby enabling one or more IODs, located in close vicinity of the UT, to participate in an adaptation of the set of the at least one IOD.

According to another aspect, an Input/Output Device Handler, IODH, capable of adapting connectivity of a User Tag, UT, during an ongoing communication session is suggested, where the IODH comprise processor circuitry configured to cause the IODH to: receive first information in a respective beacon signal, from a first set of at least one Input/Output Device, IOD, wherein the respective beacon signal is associated with the ongoing communication session and received by the respective one or more IOD from the UT; determine an adaptation of the first set of at least one IOD, based on second information, comprised in one or more modified beacon signal, received from a second set of at least one IOD, and instruct one or more of the at least one IOD on how to participate in the adaptation of the first set of at least one IOD, based on the determined adaptation.

According to yet another aspect an Input/Output Device, IOD, capable of contributing when adapting connectivity during an ongoing communication session, is provided, where the IOD comprises processing circuitry configured to cause the IOD to: receive a beacon signal, associated with the ongoing communication session and transmitted by a User Tag, UT; determine, based, at least partly on content of the received beacon signal, indicating whether the received beacon signal is a modified beacon signal or not, if the received, beacon signal is to be forwarded to an Input/Output Device Handler, IODH, or if the IOD is to refrain from forwarding the modified beacon signal, and forward, to the IODH, at least part of the content of the received beacon signal, thereby enabling the IODH to determine how the IOD is to act during the adaptation of the set of at least one IOD, in case it is determined that the received beacon signal is a modified beacon signal and that the at least part of the content is to be forwarded.

### BRIEF DESCRIPTION OF DRAWINGS

Embodiments will now be described in more detail in relation to the accompanying drawings, in which:

FIG. 1a is a signalling scheme, illustrating the signalling between an UT, a plurality of IODs and an IODH according to one embodiment.

FIG. 1b is signalling scheme, illustrating the signalling between an UT, a plurality of IODs and an IODH according to another embodiment.

FIG. 2 is a flow chart, illustrating a method executable in an UT.

FIG. 3 is a flow chart, illustrating a method executable in an IOD.

FIG. 4 is a flow chart, illustrating a method executable in an IODH.

FIG. 5 is a block scheme illustrating an UT, configured, according to one embodiment to execute the method according to FIG. 2.

FIG. 6 is a block scheme illustrating an UT, configured, according to another embodiment, to execute the method according to FIG. 2.

FIG. 7 is a block scheme illustrating an IOD, configured, according to one embodiment, to execute the method according to FIG. 3.

FIG. 8 is a block scheme illustrating an IOD, configured, according to another embodiment, to execute the method according to FIG. 3.

FIG. 9 is a block scheme illustrating an IODH, configured, according to one embodiment, to execute the method according to FIG. 4.

FIG. 10 is a block scheme illustrating an IODH, configured, according to another embodiment, to execute the method according to FIG. 4.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

Various embodiments disclosed herein are directed to providing a centralized, server based approach for emulating a communication device, by using a networked set of devices, which may be referred to as Input Output (I/O) Devices (IODs) or Input Output User Devices, which have functional capabilities that are combinable to provide a user with the ability to receive and/or initiate a communication service with another communication device via a communication session when located in proximity to the user.

Some potential advantages of these embodiments include that a user can receive and initiate communication services without the necessity of a traditional all-inclusive feature-rich communication device, such as e.g. a conventional smartphone, mobile phone or tablet computer. A server, which may alternatively be referred to as a managing node or an orchestrator, from herein referred to as an Input Output Device Handler, IODH, can instead, adaptively combine available capabilities of IODs that are proximate to a user to attempt to provide a communication service, according to the user's requirements. The IODH may dynamically respond to an incoming communication request directed to a user or an outgoing communication request from the user by operationally utilizing, or orchestrating, available IODs which are proximate to the user, to form a combined interface through which a user terminal emulation application executed by a server provide user terminal functionality for a requested communication service. The mentioned server-based approach can thereby provide low cost, adaptable communication services to users.

Dynamic allocation of capabilities of IODs, whenever and wherever the IODs are in the proximity of a user, enables efficient and flexible use of existing hardware, such as e.g. televisions, conference equipment, laptops, surveillance cameras, connected household appliances, connected vehicles, connected vessels or screens that are capable of providing, what can be referred to as User Interface (UI) functionality to a user during execution of a communication service. The user thereby has reduced or no need to carry an expensive and all-inclusive user terminal, such as e.g. as a smartphone, that includes all necessary UI capabilities, display device, keyboard, speakers, etc. The user may instead carry a less complex hardware device, herein referred to as a UserTag (UT), which operates to identify the user over a wireless cellular communication interface, or non-cellular communication interface, such as e.g. a near field communication (NFC) interface, Wi-Fi, Bluetooth, Bluetooth Low Energy (BLE), Near Field Communication (NFC) or Radio-Frequency Identification (RFID) and to access the user to one or more of the IODs. In its simplest form, an UT can be a simple, stand-alone electronic device, such as e.g. a toggle, having limited capability for transmitting, but an UT may alternatively be arranged as a conventional smartphone, smartwatch, User Device (UD), or User Equipment (UE), capable of flexibly providing UT functionality to a user. Alternatively, any type of conventional device which does not require any human interaction, such as e.g. an Unmanned Autonomous Vehicle (UAV), or an Internet of Things (IoT) device, may be capable of operating as an UT.

Once an UT has access to suitable capabilities or functionality of one or more IODs and a communication session has been established with appropriate service providing functionality, a user will be able to access at least one out of various possible types of services, such as e.g. Video on Demand (VOD), Streaming Video Services, Real-time Conversational Video or Internet Browser Applications. The service providing mechanisms are however, out of scope of this invention, which instead lay a focus on how the IODs are selected and adapted once an ongoing communication session has been established between an UT and a server, capable of providing the respective service. Consequently, the scope of the invention as disclosed herein is to maintain an ongoing communication session where the capabilities, provided via IODs can be dynamically adapted whenever the demand is changing. It is to be understood that, in the present context, capabilities can be construed broadly, as capabilities as such, such as e.g. display capabilities, allowing use of a display provided by an IOD, or a certain degree of available capabilities, such as e.g. a certain amount or degree of available interface or resource (CPU, memory, battery, bandwidth, etc.) capabilities.

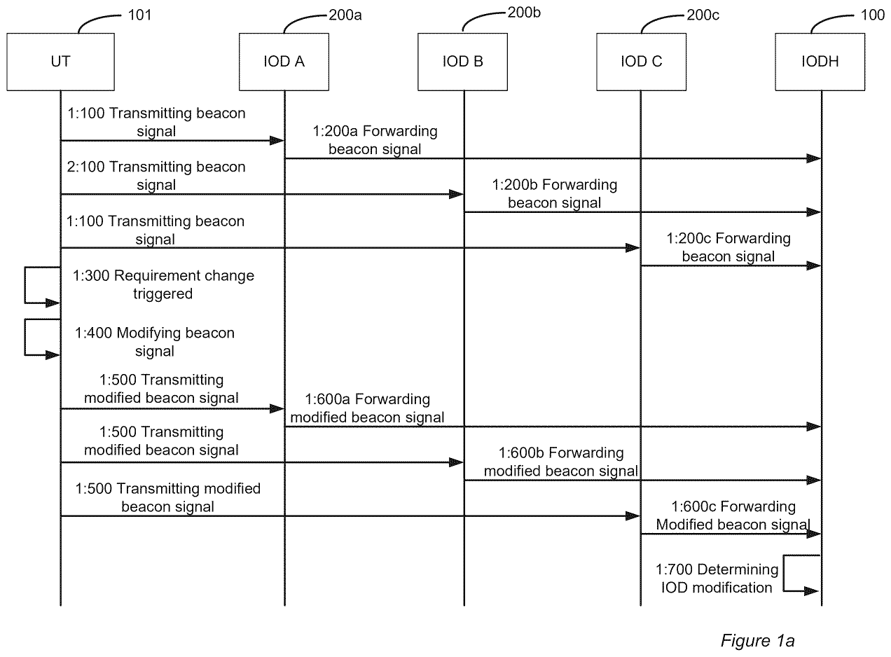

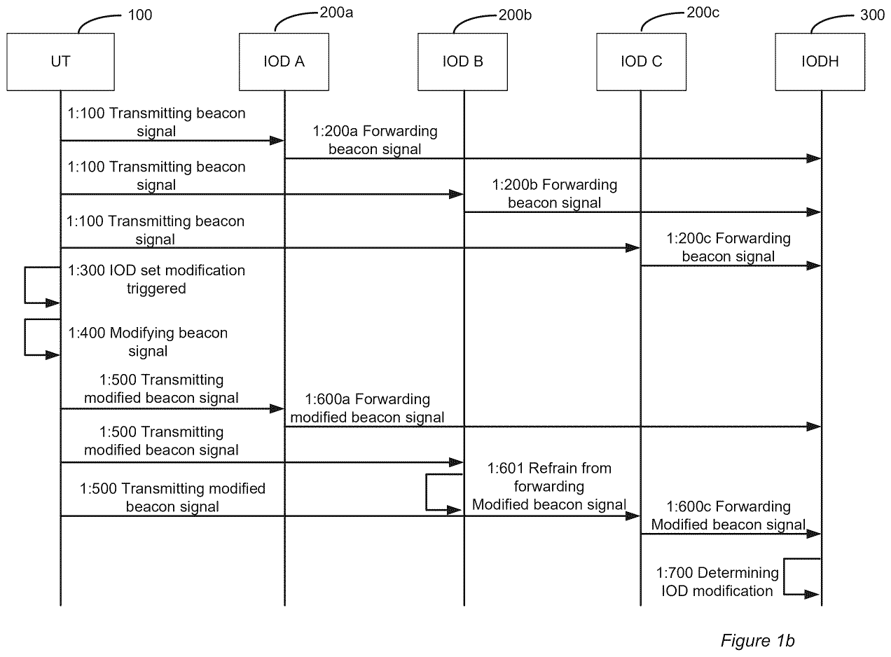

A procedure for enabling a user or a device to have an impact on which IODs, or capabilities that are to be used by a communication session will now be described in further detail with reference to FIGS. 1a and 1b. This procedure is based on the use of signals, referred to as beacon signals, which are arranged accordingly and transmitted by UTs, having an ongoing communication session with an appropriate server, such that IODs, located sufficiently close to the transmitting UT will be able to receive such signals. The receiving IODs then forward these received beacon signals to an orchestrator, capable of orchestrating the IODs. Such an orchestrator is from hereinafter referred to as an IODH, where content of consolidated beacon signals, received from the mentioned IODs, are used for determining a future configuration of IODs for a mentioned communication session. Alternatively, the beacon signals are forwarded to the IODH via an EAP Authenticator, e.g. if EAP signaling is applied for the mentioned communication.

The beacon signals allow the IODH to keep track of the available IODs, and make use of information of the beacon signals to estimate or determine the geographical location of the IODs, and to use this information when determining how available IODs are to be used by the UTs. However, by also allowing an UT to modify a beacon signal when requirements with respect to used capabilities change, and by allowing IODs and the IODH to recognize such modified beacon signals, an even more dynamic mechanism is provided.

As a prerequisite to the suggested method, a communication session has already been initiated between the UT and a server (not shown) capable of providing a requested service. FIG. 1a is a signaling scheme, illustrating how beacon signals transmitted by a UT 100 during such an ongoing communication session can be handled by a system, comprising a plurality of IODs 200a,200b,200c, which may be referred to as an IOD set, and an IODH 300, managing or orchestrating the IODs 200a,200b,200c.

It is to be understood that the system presented herein typically comprise also additional functional entities, such as e.g. the already mentioned server, providing a service to the UT 100, and possibly also an Authenticator, and that the described process may comprise further steps, but that only those entities and steps needed for understanding the core of the invention as disclosed herein have been incorporated into the figures of this document, including FIGS. 1a and 1b.

In a first step 1:100 of FIG. 1a, the UT 100 is transmitting a beacon signal, in a conventional way, i.e. comprising data, enabling an IODH to estimate or determine the location of the IODs 200a, 200b, 200c, typically by way of broadcasting the signal, repeatedly at a certain, known interval. The transmitted beacon signals are received by IODs 200a, 200b, 200c, located in the vicinity of UT 100, i.e. sufficiently close to the UT 100 for being able to successfully receive the beacon signal. In the present example all three IODs, 200a,200b,200c, are able to receive the conventional, so far, unmodified beacon signal, which comprise at least a session ID, and possibly also a MAC and a freshness parameter, such as e.g. a sequence number. All of the mentioned IODs 200a, 200b, 200c then forward the received beacon signal to the IODH 300 in subsequent, steps 1:200a, 1:200b and 1:200c, respectively. Once the beacon signal has been received by the IODH 300, IODH 300 will be able to consider the received information accordingly, for the purpose of orchestration.

In another step 1:300 a change of requirements from the IOD set is triggered at the UT 100, e.g. by identification of a raised demand for specific, so far, unavailable or different, capabilities, or by identifying the occurrence of an event at the UT 100, which calls for a change of the present IOD set, but which does not necessarily specify any specific capability demands, and in yet another step 1:400, the UT 100 is responding to the changed requirements by modifying the beacon signal, according to the relevant trigger, which comprise, changing the content of the beacon signal, thereby enabling it to indicate, more or less detailed, that the present IOD set need to be reconsidered by the IODH 300, with or without support from the IODs 20p0a, 200b, 200c, as will be further clarified below.

In addition, as will also be described in further details below, the modified beacon signal may also comprise information on how the modified beacon is, or is intended to be, transmitted by the UT 100, such that also this information can later be used by the IODH 300, for further support when construing conditions and demands of the UT 100 in relation to the IODs 200a, 200b, 200c, and when determining how to handle forwarded beacon information and how to modify an IOD set. The modified beacon signal is then transmitted in step 1:500, allowing each of the IODs 200a, 200b, 200c, still capable of successfully receiving also the modified beacon signal, to do so.

As indicated in the example of FIG. 1a, each IOD 200a, 200b, 200c which has received the unmodified beacon signal in one of steps 1:200a-1:200c also receives the modified beacon signal, and each of these IODs 200a, 200b, 200c also forwards this beacon signal to the IODH 300 in respective steps 1:600a, 1:600b and 1:600c. The forwarding may, depending on the configuration of the system, mean that only information identical to the information received by the IODs 200a, 200b, 200c is forwarded to the IODH 300, or that the forwarded beacon signal is accompanied by further information, added by the respective IOD 200a, 200b, 200c, where such information may e.g. include an indication of the signal strength at which the respective IOD 200a, 200b, 200c received the modified beacon signal, and/or that only parts of the received information, which is found necessary to the IODH 300 is forwarded to the IODH 300. This means that, whereas only information which was identical to the information received by the respective IOD 200a, 200b, 200c was received by the IODH 300 in steps 1:200a, 11:200b and 1:200c, the information provided to the IODH 300 in steps 1:600a, 1:600b and 1:600c may, depending on one embodiment, be identical, or distinguishing from the information received by a respective forwarding IOD 200a, 200b, 200c, based on additional information, added by the IODs 200a, 200b, 200c, removed information, or a combination of both. By allowing each IOD 200a, 200b, 200c to adapt the information about to be forwarded, each IOD 200a, 200b, 200c will be able to support the IODH 300 by provided further useful information, or assure that certain information, considered not needed by the IODH 300, will not be forwarded to the IODH 300. More specifically, each IOD 200a, 200b, 200c may apply filtering for determining if the received information will be needed by the IODH 300 or not. It is to be understood that the signal strength may have been forwarded already with unmodified beacon signals, e.g. in order to assist the IODH 300, when estimating the geographical locations of the IODs 200a, 200b, 200c. However, according to the present invention, such information may not only be used by the IODH 300 for estimating the geographical location of the IODs 200a, 200b, 200c, but also for adapting the IOD set.

In another step 1:700 the IODH 300 considers the information, received from all IODs 200a, 200b, 200c, that have forwarded information, here all three IODs, and determines, based on this information, how the presently active IOD set is to be adapted in order to meet with the changed demand, indicated by the UT 100.

FIG. 1b is illustrating how a modified beacon signal can be handled by a system according to another embodiment, where filtering of the modified beacon signal is applied by the IODs 200a,200b,200c, i.e. the IODs 200a, 200b, 200c not only forward modified beacon signals, but in addition they participate in the evaluation process by determining which parts of the modified beacon signals that are to be provided to the IODH 300 for consideration, and which parts that do not need to be considered by the IODH 300, and may, for this reason, refrain from forwarding the modified beacon signal, or parts of the modified beacon signal. Steps 1:100-1:500 are identical in both embodiments and figures. However, as can be seen in FIG. 1b, only IODs 200a and 200c forwards all or parts of the modified beacon signal, whereas, as indicated in step 1:601, IOD 200b refrains from forwarding any signal, due to that, even though all three IODs 200a, 200b.200c may be capable of receiving the modified beacon signal successfully, certain conditions for forwarding the same by IOD 200b are not fulfilled, i.e. IOD 200b does not consider it to be a prospect for a modified set of IODs for the ongoing session. Such a decision can e.g. be due to that the IOD 200b is already busy, serving another communication session, or due to that the signal strength of the modified beacon signal, although being sufficient for being able to receive the modified beacon signal, is below a minimum threshold value set for the IOD 200b.

The procedures described in the signaling schemes according to FIGS. 1a and 1b, are typically repeated as long as a communication session is ongoing, and different procedures, associated with different communication sessions and different associated IOD sets are also typically managed in parallel by an IODH 300. Even though both FIGS. 1a and 1b are indicating that the IODs 200a, 200b, 200c are forwarding unmodified and modified beacon signals directly to the IODH 300, these signals may, alternatively, as already mentioned, be transmitted via an authenticator (not shown), such as e.g. an EAP Authenticator, so that the EAP Authenticator thereby can assure that only authenticated beacon signals are receive and processed by the IODH 300. However, if the system is configured so that the beacon signals are not verified by an EPA Authenticator, they may instead be verified by the IODH 300. If e.g. a beacon signal is formatted as an EPA identity response message, an IOD 200a,200b,200c may, in its simplest form, forward such a message to an EAP Authenticator, whereas, according to another embodiment, the IOD 200a, 200b,200c is instead configured to first inspect the beacon signal, identifying the beacon signal as either a regular identity response, in which case the beacon signal is forwarded to the EAP Authenticator, or as a beacon identity response, in which case it is instead forwarded to the IODH 300, for processing by the IODH 300.

The UTs, may, as already mentioned, be anything from a minimalistic, constrained device, comprising more or less only communication capabilities, and some kind of triggering means, which can either be activated manually or automatically, without requiring any human interaction, for enabling triggering of a modification of a beacon signal, to a more or less manually or automatically handled, complex communication device. The UT may comprise some UI functionality for allowing a human or automated user to trigger a modified beacon, but, as mentioned above, also a UT lacking UI functionality may be capable of the mentioned triggering, e.g. by triggering based on geographical location of the UT, time of the day, day of the week, or any other parameter, which can be recognized by the UT.

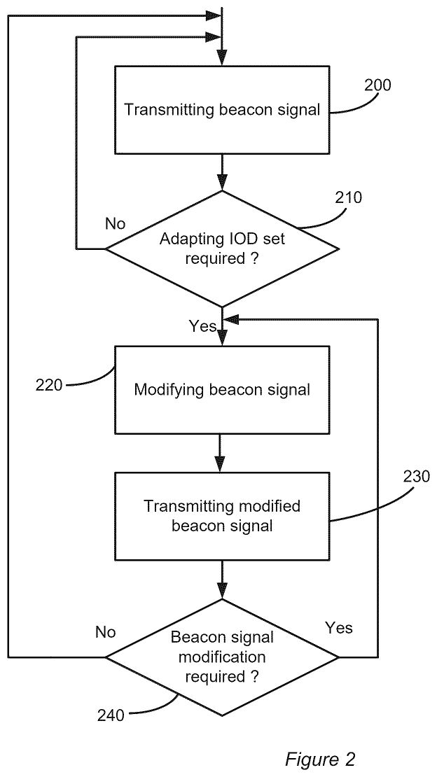

A method executable at a UT, capable of enabling adaptation of connectivity with available IODs during an ongoing session, by modifying beacon signals, as described herein, will now be described in further detail with reference to FIG. 2. As a prerequisite, it is considered that an UT is engaged in an ongoing session with a service via a set of one or more IODs, and that the method is executing until the ongoing session is terminated, i.e. a conventional or modified beacon signal, as described herein, will be transmitted with a certain interval between transmissions, as long as a session is ongoing at the UT. For battery saving purposes, a repetition scheme applied for the beacon signals may be adaptive, such that e.g. the beacon signal is transmitted less frequent during night than during day.

As already mentioned above, a beacon signal is typically transmitted by an UT on a continuous basis for an ongoing session, as indicated with a first step 200, i.e. as long as the checking of whether a modification of the beacon signal is required or not, as shown in another step 210, results in that no modification is required. However, once such a trigger is identified by the UT, the present beacon signal is to be modified, according to relevant criteria, as indicated with step 220.

A modification of a beacon signal may be based on one or more criteria. According to one embodiment, a user interaction is detected at the UT, where the user interaction is indicating a request for adaption, or at least evaluation of the possibility of an adaptation, of an IOD set. The trigger to modify a beacon signal may be initiated manually by a user of the UT, e.g. by activation of a physical or digital button; automatically, by relevant logic being activated at, or in connection to the UT, e.g. based on the occurrence of a certain event, such as e.g. the UT entering a specific geographical area, which is recognizable by the UT, or by a combination of a manual and an automatic decision. User is here to be construed as a human user, or an autonomous device or machine, being capable of handling relevant functionality of a UT, including triggering a modification of the beacon signal.

According to one embodiment, a trigger responds to an instant demand for a change of beacon signal, whereas according to another embodiment, the fact that a modification is required may be a decision which is manually triggered, by a first trigger, by a user, recognizing e.g. that an additional capability is soon to be required or evaluated, whereas the time instance for the actual modification of the beacon signal may be triggered separately by a second trigger, following the first trigger, e.g. due to the same or another trigger criteria than was applied for the first trigger. Such a subsequent trigger may e.g. be executed automatically, after an initial manual decision has been taken, such that e.g. the modified beacon signal is transmitted in a certain time slot, or once it has been determined that also a second event has occurred. According to yet another embodiment, also the actual time instance for transmitting a modified beacon signal is determined based on a manually executed trigger.

Depending on whether the decision on how to adapt the IOD set, in response to reception of a transmitted, modified beacon, is taken completely by the IODH, i.e. the UT only triggers when to modify the IOD set but has no impact on how the IOD set is to be adapted, or whether the UT also has an influence on the mentioned adaptation, the modified beacon signal can be assembled at the UT, so that it comprises one of different possible combinations of information, which is inserted into different new data fields, adapted therefore, as will be described in further detail below.

According to another embodiment, a trigger may be completely automatic, such that e.g. when one or more sensors indicate that a specific event has occurred, e.g. when an UT has entered into a certain environment. Such an automated procedure may also be based on one or more profiles, where each profile is associated with one or more events, tasks, environments or use case scenarios, and possibly also event specific capability requirements. Thereby, one or more sensors, incorporated on, or accessible to an UT, may be used for indicating that a certain event or use case has occurred, and, thus, activating a certain predefined profile, which triggers a specific modification of, and an insertion of a certain set of information to the beacon signal, according to the selected profile, corresponding to a raise of a certain demand, such as e.g. information on a certain set of required capabilities.

By way of example, a profile may be referring to a specific type of video meeting, comprising capability of the requirements, screen, touchpad, camera, speaker and microphone, whereas another profile, referred to as document editing, may comprise capability requirements limited to a screen and a mouse and a keyboard; a touchpad; a scratchpad or a pointing device. Different environments may be specified e.g. as work, home and public transportation, each being associated with different capability requirements by default. Profiles could also be specified according to e.g. time of day and or weekday, thereby profiling certain capabilities, distinguishing default profiles for normal working hours from normal spare time, as well as week days from weekends. A user of a UT may also be able to activate a certain profile, associated to a certain task, such as e.g. a video call or document editing, by scanning a specific, associated NFC tag or QR cod, or similar, on demand. Alternatively, such profiles may be accessed and activated based on voiced control.

According to another embodiment, a modification demand is based on the determination that the UT is located in a certain geographical location, requiring an adaptation of the set of at least one IOD, such that e.g. a user approaching home, triggers a UT to transmit a modified beacon signal, requesting capabilities needed for assisting the user in entering the home in a secure manner. According to yet another embodiment, time aspects, such as e.g. the occurrence of a certain time instance, a certain day of the week, or the entering into a certain time interval, may determine that a modified beacon signal need to signal a change of requirements.

Once the beacon signal has been modified, the modified beacon signal will replace the, so far, conventional beacon signal as the signal to be transmitted by the UT, as indicated with step 230. The transmission of the modified beacon signal will typically continue for a certain number N of transmissions, after which a regular beacon is again transmitted. Alternatively, transmission of a modified beacon may be repeated for another N transmissions, in case it is determined that the first N transmissions have failed, e.g. due to that a user does not get access to the IODs wanted or expected for a specific session, thereby e.g. re-pressing an activation button on the UT, in order to make a new attempt to update the IODs.

According to one embodiment, a beacon signal, preceding the modified beacon signal, may comprise information which may be relevant when handling a modified beacon signal by the IODs and IODH. Such a beacon signal may e.g. comprise one or more of an indication of the power class, applied by the UT when transmitting the preceding beacon signal and an indication of a maximum allowed transmission power level, applied by the UT when transmitting the preceding beacon signal, so that the IODH can use such information e.g. for estimating the geographical location of a respective IOD.

According to one embodiment, the UT may transmit one modified beacon signal with a flag set to “modification requested” and by applying a starting transmit power, followed by N subsequent, modified beacon signals, which are transmitted with gradually lowered transmit power, i.e. at each transmission step, the transmission power is reduced with an amount, which may typically be within the range 1-10 dB. In such a scenario only IODs close to the UT will receive and forward the information in the latest of the N modified beacon signals. Thereby an IODH may be able to estimate which IODs that are located closest to the UT, based on the received modified beacon signals, out of the N forwarded ones.

Alternatively, the modified beacon signal may comprise transmission configuration data to be transmitted e.g. only in an initial beacon. Thereby one or more of the power class, maximum and/or minimum transmission power applied by the UT may be provided to the IODs and the IODH, allowing the IODs to use such information for determining which received beacon signals to forward to the IODH, or allowing the IODH to use such information when analyzing the forwarded beacon signals and determining how to adapt the IOD set.

According to another embodiment, a first transmission, dropping to a low transmission level, may be followed by N repetitions where the transmit power is gradually increased, so that the IODH can determine, e.g. from a freshness parameter, that previous transmissions have been missed and may consider only the signals first received from the IODs, as received from the most preferred IODs.

According to yet another embodiment, the UT may, in a first transmission also include radio transmission details, indicating to the IODH that, for a certain session ID, N transmissions, with constant or gradually increasing or decreasing transmission power, will follow the first one. Thereby the IODH will be able to use also this information when determining the relevance of received information on a modified beacon signal. Alternatively, the radio transmission details to be applied are applied according to preconfigured details known to all entities involved in the handling of the modified beacon signals. According to yet another embodiment, the occurrence of a certain event is decisive of a modification of a beacon signal.

As already mentioned, the content of a modified beacon signal may vary, depending on what data an adaptation of an IOD set is to be based on. In its simplest form the modified beacon signal comprises a session ID, and an indication, capable of indicating that a modification is required, where the added content may comprise added data fields of the beacon signal, configured as follows.

Session Id; Modification Indicator/Flag (1)

The session ID is identifying the relevant, ongoing communication session which the modified beacon signal is associated with. Based on this parameter, sets of IODs, available to a user of a certain UT, can be adaptively modified as long as the communication session is ongoing, i.e. has not been terminated, since the IODH will be able to distinguish modified beacon signals associated with different communication sessions from each other. Furthermore, some capabilities, such as e. g, a mouse, may not be suitable to share by different ongoing communication sessions, whereas others, such as e.g. a display, may be suitable for sharing. The modification indicator can in its simplest form be provided e.g. in the form of a logical flag, which, if set to “true”, or “1”, indicating that the signal is a modified beacon signal, whereas if set to “false” or “0”, the signal is to be construed as an ordinary or unmodified, beacon signal. If only a session ID and a modification indicator is used in the modified beacons, an adaptation of an IOD set will be made by the IODH without any impact on the decision from the UT.

As will be exemplified below, the indication mentioned above may alternatively either be replaced by, or accompanied by, other detailed information on the actual required adaptation of the IOD set, which enables receiving entities to distinguish a modified signal from an unmodified one.

Even though the simplest modified beacon signal for executing the suggested method, as suggested above, only comprise the two added fields, a sufficiently secure arrangement normally will require also the addition of further security related fields, thereby adding also one or both of the following:

Freshness Parameter, Cryptographic Protection (2)

The freshness parameter is a parameter which is updated at the UT for each transmission, thereby allowing a receiving entity to determine if a received beacon signal is a new signal or a replayed one. For this purpose, a sequence number (SQN), which is updated for each beacon transmission, can be applied. Such a sequence number may e.g. apply wrapping, i.e. once bit-space runs out, the sequence starts again from 0.

Cryptographic protection will reduce the risk of spoofing beacon signals. By applying some sort of cryptographic proof of originator, such as e.g. a keyed hash (Message Authentication Code (MAC)) over the modified beacon, or at least parts of a modified beacon signal, such as e.g. at least the session ID, the modification indicator/flag and the SQN, these most sensitive parts of the forwarded information can be protected. Alternatively, even though cryptographic protection at all times is typically preferred, the cryptographic protection may alternatively be applied only in situations when the Modification indicator/flag indicates that a modification is required.

In case the Extendible Authentication Protocol (EAP) is applied for authentication, MAC may be calculated, using a key derived from EAP authentication, such as e.g. Pairwise Master Key (PMK), or a key derived from PMK. In such a scenario, a stand-alone Authenticator or an Authenticator forming part of the IODH use an acquired PKM, possibly together with the session ID, to derive IOD specific session keys. The UT, here acting as an EAP client, also derives the PMK in such a scenario. Thereby a key that can be used directly or indirectly for protecting the beacon is provided.

According to another embodiment a beacon signal may also comprise information specifically on capability requirements, i.e. specific information on which capabilities that will be required in order to maintain an ongoing session, even though the conditions for it may have changed during the session. Change of capability requirements may be applied such that the UT is signaling e.g. a requirement for removal of capabilities, allocated to an ongoing communication session, which are no longer required by the ongoing communication session, e.g. due to completing a certain task. Alternatively, a change may signal a requirement to add capabilities to an ongoing communication session, which capabilities are required by the ongoing communication session, e.g. due to entering a conference room, raising a demand for conference facilities. Replacing of one type of capabilities with another type, better suited for an ongoing communication session may e.g. be exemplified by requesting a replacement of a small screen with a bigger screen when entering home or work, or when a certain event, requiring a bigger screen, is triggered at the UT.

According to one embodiment, a modified beacon signal, comprising a session ID and a capabilities field, where the latter is replacing a modified beacon signal flag, may constitute a relatively simple modified beacon signal, whereas, according to another embodiment, the mentioned fields may complement a modified beacon signal flag. However, as mentioned above, in a typical scenario the modified beacon signal will also comprise a freshness parameter and some type of security protection for at least the most critical part of the signal, in order to provide at least a minimum of security protection, when signaling that an update of an IOD set is required.

A capabilities field, added to the modified beacon signal, may comprise an indication of one or more capabilities which are determined to be required by a specified, ongoing communication session, and may comprise an indication of e.g. one or more of: screen, display, speaker, camera, microphone, mouse, keyboard, touchpad, Inertial Measuring Unit (IMU), light source, sensor and actuator.

Alternatively, some or all of the indicated capabilities may be even more detailed, in case a broad term is not sufficiently descriptive for the IODH, such that a camera capability may be specified e.g. as a 360 camera or an thermal camera, a display may be specified e.g. as a holographic display or an Electric Active Polymer (EAP) display, a sensor may be specified e.g. as a temperature sensor or an Inertial Measuring Unit (IMU), a light source may be specified e.g. as a LED light or infrared light or an actuator may be specified e.g. as a touch button or a robotics arm. The capabilities field may e.g. be configured as a field, comprising a plurality of bytes, where each bit is indicating a specific type of required capability category.

By way of example, the least significant bit could indicate a mouse, the second least significant bit a screen, whereas the third least significant bit could indicate a microphone. Alternatively, a plurality of bytes may represent each category, thereby allowing one or a plurality of the same types of capabilities, such as e.g. two screens, or different types of capabilities within one category, such as e.g. different sensor types, to be indicated. Even in a scenario with a very low complex UT, such as e.g. a UT with only one actuation button, a system for identifying various types of capabilities may be applied, if e.g. the UT is configured such that pressing of the button a certain number of times is interpreted as symbolizing a request for different, respective types of capabilities. Thereby, also a fairly simple UT, only comprising one button, may provide a number of selectable options and a wide range of flexibility to a user. According to another embodiment, a further dedicated button, functioning as a “profile” button is configured to be used for selecting one of the, previously mentioned, profiles, so that certain sets of capability requirements can be selected in that way, thereby simplifying for a user to have a suitable request assembled, requiring minimal impact from the user.

Depending on type of trigger, either the user actuation of one or more actuators, logic of the UT or a combination of both may initiate a consideration according to any of the embodiments suggested above, where also different considerations may be mutually weighted and/or prioritized according to certain static rules, or, according to more dynamic rules, where one or more of e.g. geographical location, time of the day, type of, or content of session, the occurrence of a certain event or the estimated distribution of IODs, may also be considered, alone or in combination.

The adapted beacon signal may be configured as a plain bit-string, carrying information according to any of the embodiments above. Alternatively, the information presented above could be carried as an identifier in an EAP Identity Response message, the EAP message acting as the beacon. In such a scenario the modified beacon signal may also comprise a beacon ID, being a parameter specifically distinguishing a beacon signal from an EAP identity response message. With the latter approach, the UT could, when not having an active communication session, broadcast a beacon in the form of an EAP Identity Response message, with the carried identity being the identity of the UT, and pointing to an associated EAP server. Once the UT has established a communication session, the identity carried in the EAP message, acting as a beacon signal, could then be replaced with the beacon format, as discussed earlier. For the UT this would simplify things as the beacon signal would always be an EAP message, which could be used both for initial authentication and management of existing communication sessions. The EAP message could by the receiving IOD either be automatically routed to an EAP Authenticator in the domain, or the IOD could identify the beacon signal to be a communication session specific beacon and thus forward it to the IODH. If all EAP beacon signals are sent to an EAP Authenticator, it has to make the distinction between an initial authentication and a session communication beacon signal. This could be done (either by IOD or EAP Authenticator), using the dedicated beacon ID, or any other distinguishing format/content of the carried ID.

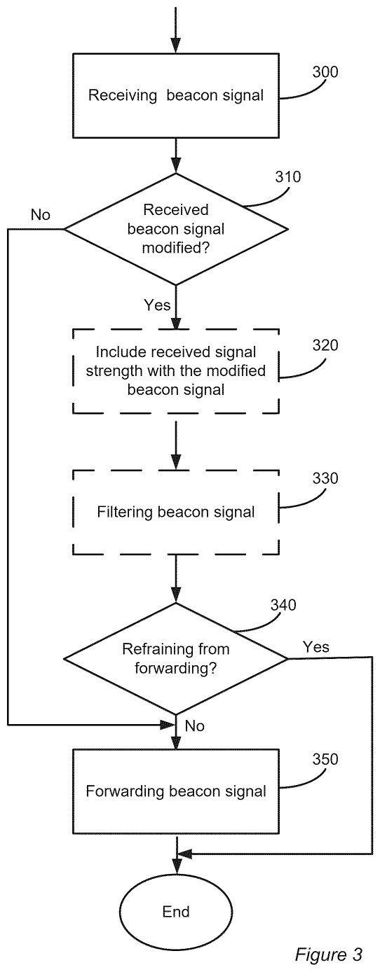

A method executable at an IOD, capable of receiving and handling a modified beacon signal, received from a UT, will now be described in further detail with reference to FIG. 3. As a prerequisite, it is considered that an UT is engaged in an ongoing session with a service via a set of one or more IODs, including the IOD on which the method is executed, as described below. Furthermore, typically a method as described herein at an IOD is typically executed at a plurality of IODs in parallel.

The IOD, is located sufficiently close to the UT to successfully receive a beacon signal, as indicated in a first step 300. As long as the received beacon signal is not identified as a modified beacon signal, as indicated with the “No” branch of step 310, the received beacon signal is simply forwarded to an IODH directly, or via an EAP Authenticator, as indicated with step 320a, after which reception of another beacon signal is awaited. In case the beacon signal is an EAP identity response, the beacon signal is typically forwarded to an EAP Authenticator, before being forwarded to the IODH by the EAP Authenticator. IODH.

However, if it is determined, at the IOD, based on the content of the received beacon signal, that the received beacon signal has been modified, as indicated with the “Yes” branch of step 310, the IOD may also just forward the modified beacon signal, leaving all evaluation of the adaptation of the IOD set to the receiving IODH. Alternatively, the IOD may contribute to the adaptation procedure according to one or more options. As indicated with optional step 320, further content, such as e.g. received signal strength, may be included with the modified beacon signal, and/or, in case a filtering function is to be applied, as indicated with optional step 330, the IOD may apply relevant filtering criteria for determining if it is to refrain from forwarding the modified beacon signal, as indicated with the “Yes” branch is step 340, or if it is to be forwarded, according to step 350, as indicated after the “No” branch of step 340. Filtering may also determine which content of a modified beacon signal to forward and which data to discard and refrain from forwarding, if required. One advantage with filtering which modified beacon signals to forward is that a receiving IODH will have to evaluate less, but more relevant information, and, thus, be less loaded. On the other hand, an advantage with forwarding all or most content of modified beacon signals, received by at least one IOD, is that the IODH will be provided with a more complete picture of available and capable IODs, and possible combinations of IODs, and, thus, may be able to make a more optimized selection and combination of IODs. The latter approach may be advantageous e.g. when the IODH is about to determine how to share sharable resources, such as screens, between different communication sessions, in an efficient way and may also be advantageous when more complex selection criteria is applied by the IODH.

In case filtering is to be applied, such filtering may, according to one embodiment, be based on received signal strength of the modified beacon signal as filtering criteria, irrespective of whether such filtering is used for determining of forwarding or no forwarding by the IOD. Consequently, the IOD may selectively forward the whole or part of modified beacon signals, only when the received signal strength is found to have exceeded a certain signal strength threshold value.

According to another embodiment, the modified beacon signal may be refrained from forwarding if the modified beacon signal comprises at least one capability field and the IOD fails to provide any of the one or more required capabilities, indicated in such a field. In such a scenario, this IOD will obviously not be useful for the ongoing session, and, thus, no relevant option for the IODH during its selection of suitable IOD set.

According to yet another embodiment, an IOD may determine that it is not capable of contributing to the communication session associated with the received modified beacon, e.g. due to serving another ongoing communication session.

According to yet another embodiment, IOD specific, capacity related information, such as e.g. its battery capacity, interface capacity, processing power, or available storage capacity may be used as filtering criteria, assuring that only IODs with sufficient amount of a certain capacity are considered by the IODH. As an alternative to one or more of the filtering criteria mentioned above, one or more of the respective parameters may instead be inserted into a modified beacon before being forwarded, so that instead the IODH may consider e.g. the available storage capacity of each available IOD when determining a suitable IOD set.

As mentioned above, rather than forwarding a modified beacon signal directly to an IODH, the IOD may forward the modified signal to an authenticator, such as e.g. an EAP Authenticator. According to yet another embodiment, the IODH may comprise such an EAP authenticator.

As already implied above, the final decision on how to adapt an IOD set in response to having received at least one modified beacon signal, originated by a UT, is made by an IODH. Even though each IOD may contribute to such a decision, it will only be the IODH which will have the overall or final picture of the present IOD situation, i.e. the presently used IODs and potential IODs, so that it, after a consolidation of content from received, modified beacon signals, will be able to evaluate all the information provided in the modified beacon signals, and select a suitable IOD set comprising one IOD or a combination of IODs for the respective ongoing communication session.

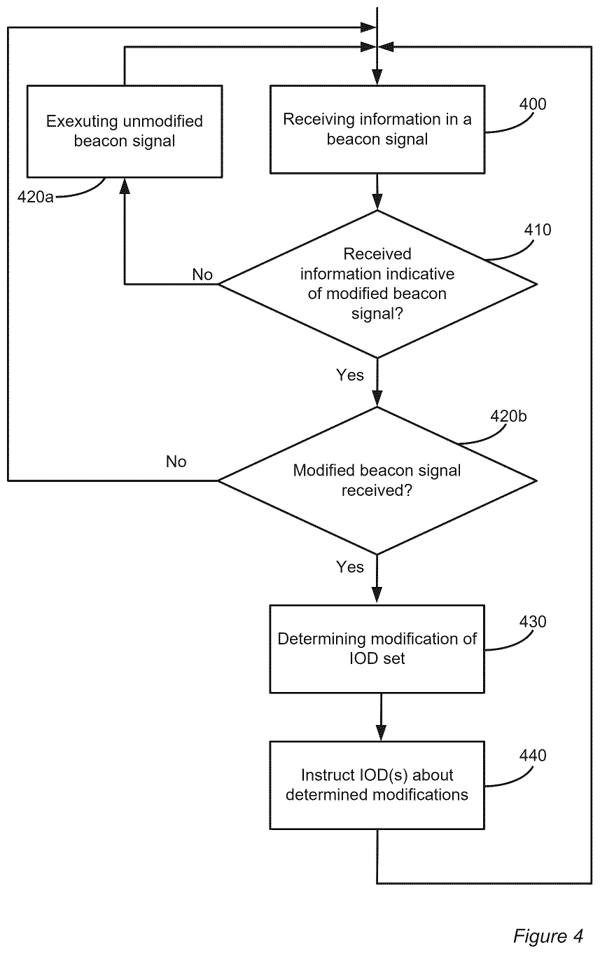

A method executable at an IODH, capable of, as part of its managing functionality, deciding on modification of sets of IODs, based on information on modified beacon signals, received from IODs, presently engaged in an ongoing communication session, will now be described in further detail with reference to FIG. 4. As a prerequisite, it is considered that at least one IOD, making its capabilities available to a UT, is forwarding received modified beacon signal information, with or without adding additional, IOD specific, information to the modified beacon signal, for evaluation and processing at the IODH.

The IODH is receiving information on a beacon signal from an IOD, as indicated with step 400. Typically, step 400 also comprises determination of freshness of the received signal, i.e. distinguishing a firstly modified beacon signal from a repeated one, wherein FIG. 4 is only describing how the first received beacon signal is handled, whereas repeated ones reaching the IODH are dropped by the IODH. By logging repeated beacon signals the IODH may use such information as a basis for determining that an attack attempt is ongoing. If the suggested feature for determining freshness is applied, step 400 may also, unless done at an Authenticator.

If the received beacon signal information does not indicate reception of a modified beacon signal, as indicated with the “No” branch of step 410, the information acquired by the IODH is executed or handled by the IODH in a conventional way, which is out of the scope of this document, as indicated in step 420a, and a new beacon signal is then awaited by the IODH. However, if the information is interpreted, by the IODH, as indicating a modified beacon signal, as indicated with the “Yes” branch of step 410, this received information is instead processed for the purpose of first determining if the present IOD set associated with the mentioned communication session need, or can be modified, based on the acquired information, as indicated with step 420b.

Determination of whether a modification of an IOD set is required or possible or not, is achieved by comparing available information on the present IOD set, such as e.g. capabilities available from the mentioned IOD set, with capabilities required according to the modified beacon signal information. If requirements are met, no modification will be needed and the described process is terminated, to be reinitiated again once a new modified beacon signal information is received by the IODH, as indicated with the “No” branch of step 420b. The latter situation may e.g. appear when requirements from the UT are indicating a required need of a change of an IOD set, but where the IODH determines that continued execution of the ongoing communication session will be possible, and that a change of the IOD set will not improve the overall situation among the ongoing sessions. Alternatively, a present set of IODs may be maintained, in a “best possible” scenario, e.g. in case no additional or alternative IODs are available.

If, however, it is determined, by the IODH, that the present set of IODs will not be able to provide a service according to the known requirements, and that there are additional or alternative IODs available, it is determined how the IOD set should be modified, as indicated with step 430. Such a determination should have the goal of selecting the most optimal IOD set, based on the applied criteria, and may be executed based only on the content of the received modified beacon signal, available to the IODH, or based on the mentioned information, in combination with additional, IOD specific information, such as e.g. received signal strength, included by the IODs with the forwarded modified beacon signal, thereby constituting modified beacon signal information. Furthermore, the IODH typically have access to, and consider, one or both of certain prestored information on the IODs, as well as logic, i.e. rules on how to consolidate, evaluate, and prioritize available information, possibly including rules on how to weight various parameters in relation to each other.

More specifically the IODH may select IODs/capabilities, by determining removal of one or more IODs which can only provide capabilities, which will no longer be required, or it may remove IODs with only one capability and replace it with another IOD, comprising a plurality of the required capabilities. If presently unavailable capabilities are required, one or more suitable IODs may be added or replace less suitable ones, i.e. adding, removal and replacing of IODs may be relevant during the determination phase of step 430. If a plurality of suitable IODs are available, the one estimated to be closest to the UT may be selected, if such information is available to the IODH. However, other considerations, such as e.g. active constellations of shared resources between different ongoing communication sessions or combinations of capabilities at different IODs may be considered as well. According to one embodiment, the IODH may also or alternatively take user preference into consideration, e.g. such that a certain user has specified that, in case an IOD of a specific type is among available options, this IOD is always, or under certain conditions, to be used or switched to if the received signal strength is above a certain threshold value.

Once a determination on a modification has been made, the relevant IODs are instructed of this determination by the IODH, in another step 440, after which the method is repeated the next time a modified beacon signal is received.

Although FIG. 4 is showing a flowchart where only one beacon signal is received, it is to be understood that, in a typical scenario, involving more than one IOD, which are all handling the same communication session and which have received an associated, modified beacon signal, the determination of steps 420b and 430 will be based on the consolidated information received from all the relevant IODs. More specifically, if the requirements of the present IOD set fulfil the requirements also according to the received modified beacon signal, the present IOD set is maintained, whereas if this is not the case, it will be modified, by considering information from all relevant IODs in step 430. Consequently, all IODs involved in the determined modification are instructed in separate instructions, according to step 440.

The determination of a modification of an IOD set may be based on considering available IODs, where different types, such as e.g. screens, speakers, etc. of IODs may have been grouped into different respective groups, e.g. depending on combinations of capabilities. By considering received transmit power of IODs, and the available groups, as well as how received transmit power vary between different received beacon signals out of N, or parts on N forwarded signals, the IODH may be able to determine an optimized IOD set.

The IODH will determine how the present IOD set for a respective ongoing communication session shall be configured according to information accessible in the received information on one or more modified beacon signals.

The IODH will use an acquired beacon identifier to identify the received signal as a beacon signal, unless the IODH is configured to identify such a signal accordingly, based on other content of the received information, such as e.g. from presence of information on required capabilities. The IODH may also identify a session ID from the received information, so that it can distinguish and consolidate information associated with a specific communication session. By further evaluating freshness parameters of received modified beacon signals, the IODH will be able to distinguish a first modified beacon signal from subsequent ones.

If at least part of the received information is also protected by a cryptographic proof of originator, the IODH will verify the integrity of these parts of the information accordingly. As already mentioned, the IODs may, according to one embodiment, also include an indication of the signal strength of the received modified beacon signals into the information forwarded to the IODH. Thereby, the IODH will be able to use such signal strength information to estimate the distance between the UT and a respective IOD, so that, based on these estimates, those IODs that are estimated to be located closest to the UT can be prioritized when determining how to best modify an IOD set. If capability requirements are included in the received information, certain possible combinations of IODs, fulfilling these capability requirements can be considered, together with other available parameters.

In addition to the information mentioned above, the IODH may also have access to further information to consider when determining how to modify the IOD set. If the IODH has access also to information on the amount of available capabilities in each relevant IOD, this information can be considered during the mentioned determination process, such that e.g. in case there is at least one IOD having two or more requested capabilities available, all IODs only having one requested capability available may not be considered as potential IODs in the modified IOD set. Corresponding considerations may be done by the IODH if e.g. one or more of battery capacity, the amount of processing power, amount of interface capacity or the amount of storage capacity available at each relevant IOD is also accessible to the IODH.

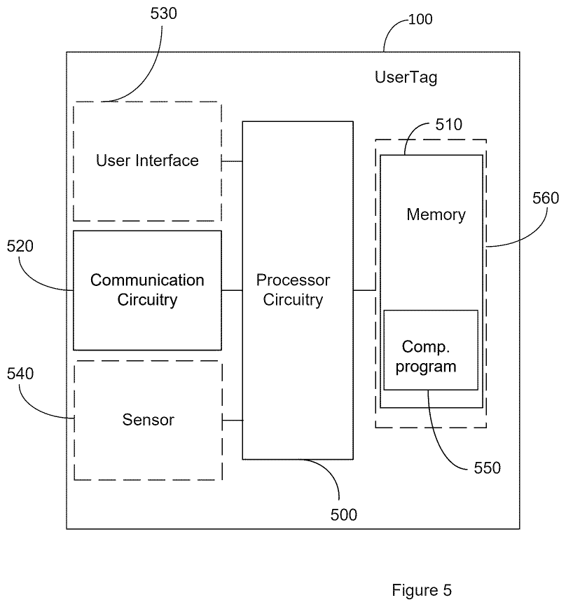

In order to be able to execute the method cited above, with reference to FIG. 2, an UT need to be adapted accordingly. An UT, configured to execute a method as disclosed herein, according to one embodiment, will therefore now be described in further detail with reference to FIG. 5. The UT 100 of FIG. 5 comprises processor circuitry 500, and a memory 510 comprising executable instructions, configured such that when executed by the UT 100, the UT 100 a method according to FIG. 3 will be performed. The memory 510 can be any combination of random access memory (RAM) and/or read only memory (ROM). The memory 510 also typically comprises persistent storage, which, for example, can be any single one or combination of magnetic memory, optical memory, solid-state memory or even remotely mounted memory. The processing circuitry 500 may comprise e.g. one or more central processing unit (CPU), multiprocessor or digital signal processor (DSP).

The computer readable instructions, configured to provide the functionality as described herein may be provided as a computer program 550, configured in the form of a computer program product 560, where the computer program product 560 may be configured e.g. as an optical disc, such as a Compact Disc (CD), a Digital Versatile Disc (DVD) or a Blu-Ray disc.

More specifically, the UT 100 is capable of enabling adaptation of connectivity of the UT 100 during an ongoing communication session, provided to the UT 100 by a service via a set of at least one IOD 200a,200b,200c, wherein the UT 100 is comprising processing circuitry 500 configured to cause the UT 100 to transmit a beacon signal, which here can be referred to as a conventional beacon signal, or a beacon signal preceding a modified beacon signal, during the ongoing communication session, via communication circuitry 520, where the beacon signal is detectable by the at least one IOD 200a,200b,200c when the UT 100 is located in close vicinity of the at least one IOD 200a, 200b,200c. Upon determining that an adaptation of the set of at least one IOD 200a,200b,200c is required, the UT 100 is configured to modify the preceding beacon signal, wherein the modification comprises including an indication in the beacon signal, indicating a request for an adaptation of the set of at least one IOD 200a,200b,200c, and to transmit the modified beacon signal, thereby enabling one or more IODs 200,a,200b,200c, located in close vicinity of the UT 100, to participate in an adaptation of the set of the at least one IOD 200a,200b,200c.

Typically, the UT 100 is further configured to transmit the preceding beacon signal, comprising transmission configuration, comprising one or more of an indication of the power class applied by the UT 100 when transmitting the preceding beacon signal, and an indication of a maximum allowed transmission power level applied by the UT 100 when transmitting the preceding beacon signal, so that, when received by an IODH 300, such information can be used e.g. for estimating the distance between the UT 100 and the IODs 200a,200b,200c.

When about to modify the beacon signal, the UT 100 is configured to include the beacon signal with specific data into respective, dedicated data fields, where such information will include at least a session identity, identifying the ongoing communication session, thereby enabling an IODH 300 to handle beacon signals associated with on specific communication session separately, and a modification indicator, indicating if an adaptation of the set of at least one IOD 200a,200b,200c is requested or not, i.e. enabling an IODH 300 to determine if the beacon signal is requesting for an adaptation of the IOD set or not.

As already mentioned, a modified beacon signal may comprise one or more additional parameters, provided in other, dedicated data fields, depending on which data that is considered to be required by the IODH 300, for being able to determine how to best adapt a present IOD set. More specifically, the UT 100 may be configured to include a beacon identifier, indicating that a signal is a beacon signal, and, thus, is to be processed according to mechanisms described in any of the embodiments disclosed herein. A freshness parameter will enable an IODH 300 to distinguish one transmitted beacon signal from a previously transmitted beacon signal. A cryptographic proof of originator will improve security by providing cryptographic protection of at least parts of a beacon signal, whereas an indicator of capability requirements for an ongoing session will provide more specific requirements on specific capabilities required by the UT 100.

If the UT 100 is configured to comprise specific capabilities requirements, such requirements may specify one or more of screen, display, speaker, camera, microphone, mouse, keyboard, touchpad, scratchpad, pointing device, Inertial Measuring Unit (IMU), light source, sensor and actuator in the modified beacon signal.

The trigger to modify a beacon signal, based on requirements for amendments of an IOD set, may be caused by or based on a number of different criteria, either alone or in a combination. According to one embodiment, the UT 100 may be configured to detect that a user interaction, indicating a request for adaptation of the set of at least one IOD 200a,200b,200c, has been executed at a UI 530 of the UT 100, such a UI 530, which is optional, may e.g. be any of a button or a touch sensitive display, or a sensor 540, such as e.g. an Inertial Measurement Unit (IMU).

According to another embodiment, the UT 100 may be configured to detect that the UT 100 has entered, and is now located in a certain geographical location, requiring an adaptation of the set of at least one IOD 200a. 200b. 200c. Alternatively, the UT 100 may detect that a certain time instance, raising a demand for an adaptation of the set of at least one IOD 200a. 200b. 200c, has been reached, or that a certain time interval has begun or expired. According to yet another embodiment, the UT 100 may instead be configured to detect that a certain event, detectable by one or more sensors, here represented by optional sensor 540 or processing logic (not shown) of the UT 100, has occurred.

The UT 100 may also be configured to repeat the transmission of a modified beacon a specific number, N, of times, such as e.g. 5 times. More specifically, the UT 100 may, according to one embodiment, be configured to lower or increase the transmission power with a certain, predetermined amount for each N repetition, after first having transmitted an initial, modified beacon signal, using a nominal transmission power.

According to another embodiment, the UT 100 may be configured to include the initial modified beacon signal with also a transmission plan, relevant for the subsequently repeated, N modified, beacon signals, thereby informing the IODH 300 on the upcoming repeated transmissions.

In case the UT 100 is configured to use a modification indicator in a modified beacon signal, and to repeat the transmission of the modified beacon signal N times, the UT 100 may be further configured to set this modification indicator only during the initial modified beacon, preceding the N modified beacon signals, thereby allowing the IODH 300 to easily distinguish a first modified beacon signal from a repeated one.

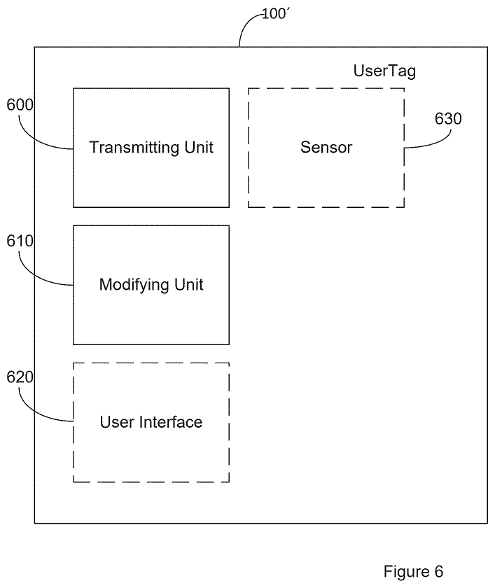

According to another embodiment, a UT 100′, comprising a number of functional units or modules, can be configured according to FIG. 6, where a transmitting unit or communication unit 600 is configured to transmit a preceding beacon signal, detectable by the at least one IOD 200a, 200b, 200c when the UT 100′ is located in close vicinity of the at least one IOD 200a, 200b, 200c, during an ongoing communication session, corresponding to step 200 of FIG. 2; a modifying unit 610 is configured to modify the preceding beacon signal, upon determining that an adaptation of the set of at least one IOD 200a, 200b, 200c is required, wherein the modification comprises including an indication to the beacon signal, indicating a request for an adaptation of the set of at least one IOD 200a, 200b, 200c, corresponding to step 220 of FIG. 2, and wherein the transmitting unit 600 is further configured to transmit the modified beacon signal, thereby enabling one or more IODs 200a, 200b, 200c, located in close vicinity of the UT 100′, to participate in an adaptation of the set of the at least one IOD, corresponding to step 230 of FIG. 2. The UT 100′ may also be configured to recognize user interactions entered to the UI 100′ via a User Interface (UI) 620. Furthermore, the UT 100′ may be configured to capture one or more parameters via one or more sensors, here represented by optional sensor 630.

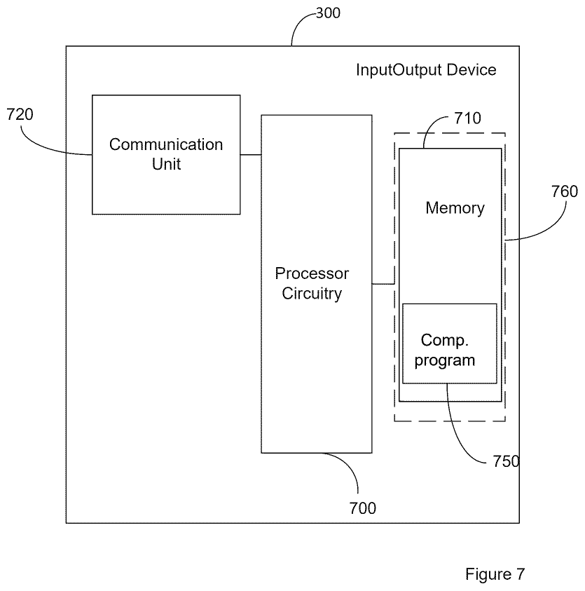

Also the IODs need to be adapted so that they are able to execute a method according to FIG. 3. Therefore, an IOD 200 configured to execute a method as disclosed herein, will now be described in further detail with reference to FIG. 7. With respect to an IOD 200, applying the mechanism disclosed herein, an IOD 200 may be any type of device, comprising communication capabilities, and at least one capability, which a user, having a UT 100, can make use of, once a communication session has been initiated between the UT 100 and a service.

Consequently, a certain communication session may make use of a set of IODs 200a, 200b, 200c, where each IOD 200a, 200b, 200c of such a set may provide different or similar capabilities, which, together, fulfil a requirement for the respective communication session, or one single IOD 200 may provide all capabilities, required for the communication session. The IOD 200 may therefore be e.g. a computer, laptop, or tablet PC, comprising a plurality of capabilities, or e.g. a display, mouse, keyboard, scratchpad, digital camera, or pointing device providing one or more types of capabilities to the communication session.

The IOD 200 comprises processor circuitry 700, and a memory 710 comprising executable instructions configured such that the IOD 200 will be able to execute a method according to FIG. 3. The memory 710 can be any combination of random access memory (RAM) and/or read only memory (ROM). The memory 710 also typically comprises persistent storage, which, for example, can be any single one or combination of magnetic memory, optical memory, solid-state memory or even remotely mounted memory. The processing circuitry 700 may comprise e.g. one or more central processing unit (CPU), multiprocessor or digital signal processor (DSP).

The computer readable instructions, configured to provide the functionality as described herein may be provided as a computer program 750, configured in the form of a computer program product 760, where the computer program product 760 may be e.g. an optical disc, such as a Compact Disc (CD), a Digital Versatile Disc (DVD) or a Blu-Ray disc.

More specifically the IOD 200, is capable of contributing when adapting connectivity during an ongoing communication session provided to a UT 100, by a service via the IOD 200, the IOD 200 comprising processing circuitry configured to cause the IOD 200 to receive, via a communication unit 720 a beacon signal, associated with the ongoing communication session and transmitted to the IOD 200 by the UT 100, after which it is configured to determine, based, at least partly, on content of the received beacon signal, indicating whether the received beacon signal is a modified beacon signal or not, if the received beacon signal is to be forwarded to an IODH 300 or if the IOD 200 is to refrain from forwarding the modified beacon signal. The mentioned consideration allows the IOD 200 to selectively forward only modified beacon signals, or parts of modified beacon signals, which are considered relevant for the IODH 300, when determining how to adapt an IOD set. Finally, the IOD 200 is configured to forward at least part of the content of the received, modified beacon signal, to the IODH 300, thereby enabling the IODH 300 to determine how the IOD 200 is to act during the adaptation of a set of at least one IOD in case it is determined that the received beacon signal is a modified beacon signal and that the at least part of the content is to be forwarded.

According to one embodiment, the IOD 200 is further configured to acquire an indication of the signal strength of the beacon signal, when received by the IOD 200.

According to another embodiment, the IOD 200 is configured to forward the received beacon signal only in case a filtering criteria for forwarding the received beacon signal is fulfilled. If filtering is applied, the IOD 200, may be configured to filter based on one or more filtering criteria, which may be based on one or more of: the signal strength of the received beacon signal, such that e.g. only modified beacon signals received at a signal strength exceeding a certain threshold value are forwarded; the battery capacity of the IOD 200, such that a modified beacon signal is forwarded from the IOD 200 only if its battery capacity exceeding a certain threshold value; capabilities available at the IOD 200, such that a modified beacon signal is forwarded only if one or more specific capabilities are available for use by a specific communication session at the IOD 200; the processing power available at the IOD 200, such that a modified beacon signal is only forwarded if the processing power available at the IOD 200 exceed a certain threshold value and the storage capacity available at the IOD 200, such that a modified beacon signal is only forwarded in case the storage capacity of the IOD 200 exceeds a certain threshold. Any of the suggested filtering criteria may be based on factual values or estimated values.

Once a modified beacon signal has been received by the IOD 200, and it has been determined that at least some content is to be forwarded to an IODH 300, the IOD 200 may further be configured to include one or more parameters into the received, modified beacon signal: the signal strength of the received beacon signal; the battery capacity available at the IOD 200, capabilities available at the IOD 200, processing power available at the IOD 200 and storage capacity at the IOD 200. Consequently, the IOD 200 may either filter a received, modified beacon signal, thereby taking a decision on whether the beacon signal shall be considered by the IODH 300 or not, or add corresponding parameter to the received, modified beacon signal before it is forwarded to the IODH 300, thereby leaving to the IODH 300 to consider also this parameter when determining how to adapt an IOD set 200a,200b,200c. Alternatively, the IOD 200, may apply a combination of both, such that some parameters are used in a filtering process, whereas other parameters are forwarded to the IODH 300.

As has been indicated above, the IOD 200 may be configured to forward a received, modified beacon signal, or parts of a received, modified beacon signal either directly to an IODH 300, or to an Authenticator, which is further configured to process the received, modified beacon signal, before it is forwarded to the IODH 300.

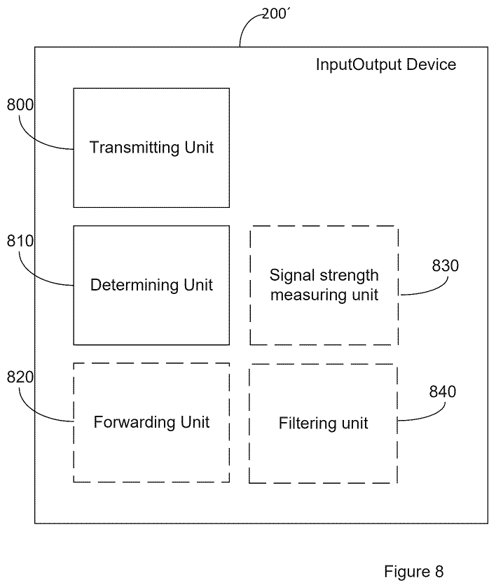

According to another embodiment, an IOD 200′ is presented with reference to FIG. 8, where a receiving unit or communication unit 800 is configured to receive a beacon signal, associated with the ongoing communication session and transmitted by the UT, corresponding to step 400 of FIG. 4; a Determining unit 810, is configured to determine, based, at least partly, on content of the received beacon signal, indicating whether the received beacon signal is a modified beacon signal or not, if the received, beacon signal is to be forwarded to an IODH 300, or if the IOD 200′ is to refrain from forwarding the modified beacon signal, corresponding to the “Yes” branch of step 420b of FIG. 4, and a forwarding unit 820, configured to forward, to the IODH 300, at least part of the content of the received beacon signal, thereby enabling the IODH 300 to determine how the IOD 200′ is to act during the adaptation of the set of at least one IOD 200′, in case it is determined that the received beacon signal is a modified beacon signal and that the at least part of the content is to be forwarded. The IOD 200′ may also comprise a signal strength measuring unit 830, which is configured to determining a signal strength of a received modified or unmodified beacon signal, and in case the IOD 200′ is configured to filter a received beacon signal it may also comprise a filtering unit 840, configured to execute such filtering, according to any of the embodiments described herein.

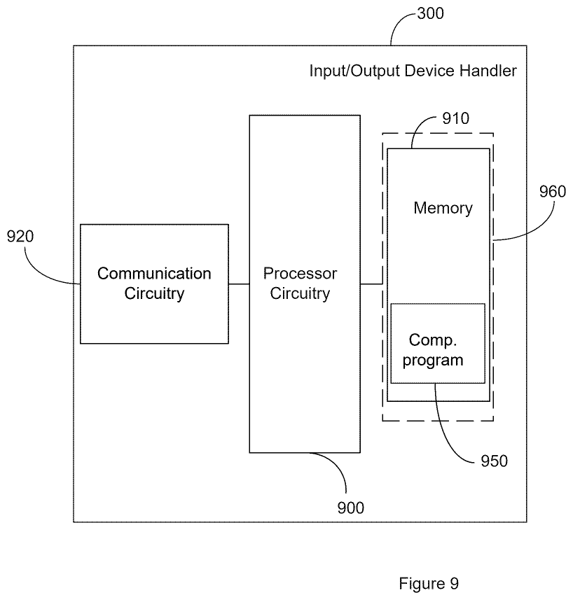

An IODH, configured to execute a method as disclosed herein, will now be described in further detail with reference to FIG. 9. The IODH 300 comprises processor circuitry 900, and a memory 910 comprising executable instructions configured such that the IODH 300 will be able to execute a method according to FIG. 9. The memory 910 can be any combination of random access memory (RAM) and/or read only memory (ROM). The memory 910 also typically comprises persistent storage, which, for example, can be any single one or combination of magnetic memory, optical memory, solid-state memory or even remotely mounted memory. The processing circuitry 900 may comprise e.g. one or more central processing unit (CPU), multiprocessor or digital signal processor (DSP).

The computer readable instructions, configured to provide the functionality as described herein may be provided as a computer program 950, configured in the form of a computer program product 960, where the computer program product 960 may be e.g. an optical disc, such as a Compact Disc (CD), a Digital Versatile Disc (DVD) or a Blu-Ray disc.

More specifically the IODH 300 is capable of adapting connectivity of a UT 100 during an ongoing communication session provided to the UT 100 by a service via at least one IOD 200a, 200b, the IODH 300 comprising processor circuitry 900, configured to cause the IODH 300 to: receive information, here referred to as first information, via communication circuitry 920, in a respective beacon signal, associated with the ongoing communication session and received by the respective one or more IOD 200a, 200b from the UT 100, from a first set of at least one IOD 200a, 200b, and to determine an adaptation of the first set of at least one IOD 200a, 200b, based on second information comprised in one or more modified beacon signal, received from a second set of at least one IOD 200a, 200b, 200c, after which the IODH 300 is configured to instruct, by the communication circuitry 900, one or more of the at least one IOD 200a, 200b, 200c on how to participate in the adaptation of the first set of at least one IOD 200a, 200b, based on the determined adaptation. It is to be understood that the first and second set of IODs mentioned above may be fully, partly or non-overlapping, considering that IODs may be removed, added or replacing one another.

According to one embodiment the IODH 300 is configured to, at least partly, base the determining on signal strength of one or more beacon signal, received by the second set of at least one IOD 200a, 200b, 200c, and comprised in the received second information.

The IODH 300 may be configured to determine an adaptation of a set of IODs 200a, 200b, 200c based on a number of different parameters, contained in the second information, alone or in a combination, such as e.g. a session identity, identifying the ongoing communication session; a beacon identifier, indicating that a received signal is a beacon signal; a freshness parameter, being a parameter which is updated each time a respective beacon signal is transmitted by an IOD 200a, 200b, 200c, thereby distinguishing one transmitted beacon signal from previously transmitted beacon signals; a cryptographic proof of originator, providing cryptographic protection of at least parts of a beacon signal, and capability requirements for the ongoing communication session. Typically, the IODH 300 is configured to base the mentioned adaptation on a set of IODs, at least partly, on a consolidation of second information, received from a plurality of IODs 200a, 200b, 200c.

In addition to what has been mentioned above, or in combination, the IODH 300 may also be configured to perform a determination on how to adapt a set of IODs at least partly on: signal strength of a beacon signal received by a respective IOD 200a, 200b, 200c; battery capacity of a respective IOD 200a, 200b, 200c; amount of processing power available in a respective IOD 200a, 200b, 200c, amount of interface capacity available in a respective IOD 200a, 200b, 200c and amount of storage capacity available in a respective IOD 200a, 200b, 200c.

According to other embodiments, the IODH 300, is configured to also consider one or more of: personal preferences of the user of the UT 100, and an estimated distance between the UT 100 and the respective IODs 200a,200b,200c, at least partly, based on received, consolidated signal strengths. With respect to the first alternative, such preferences may either be provided in the modified beacon signal, or obtained from data stored at or accessible to the IODH 300, whereas the latter information may be determined by the IODH 300, or provided from one or more IODs 200a, 200b, 200c.

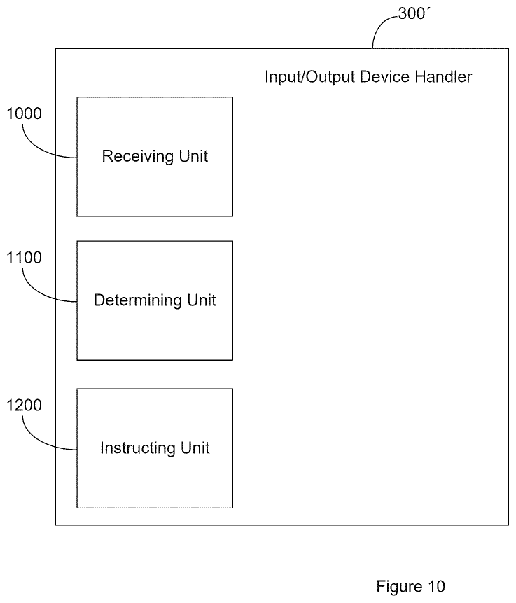

According to another aspect an IODH 300′ is presented with reference to FIG. 10, where a receiving or communication unit 1000 is configured to receive information in a beacon signal, corresponding to step 400 of FIG. 4; a determining unit 1100 configured to determine an adaptation of the first set of at least one IOD, based on second information comprised in one or more modified beacon signal, received from a second set of at least one IOD, corresponding to step 430 of FIG. 4, and an instructing unit 1200 configured to instruct one or more of the at least one IOD on how to participate in the adaptation of the first set of at least one IOD, based on the determined adaptation, corresponding to step 440 of FIG. 4.

1. A method in a User Tag, UT, for enabling adaptation of connectivity of the UT during an ongoing communication session, the method comprising:
transmitting, during the ongoing communication session, a preceding beacon signal, detectable by the at least one IOD when the UT is located in close vicinity of the at least one IOD;
modifying the preceding beacon signal, upon determining that an adaptation of the set of at least one IOD is required, wherein the modification comprises including an indication to the beacon signal, indicating a request for an adaptation of the set of at least one IOD, and
transmitting the modified beacon signal, thereby enabling one or more IODs, located in close vicinity of the UT, to participate in an adaptation of the set of the at least one IOD.

2-12. (canceled)

13. A method in an Input/Output Device Handler, IODH, for adapting connectivity of a User Tag, UT, during an ongoing communication session, IOD, the method comprising:
receiving, from a first set of at least one IOD, first information in a respective beacon signal, associated with the ongoing communication session and received by the respective one or more IOD from the UT;
determining an adaptation of the first set of at least one IOD, based on second information comprised in one or more modified beacon signals, received from a second set of at least one IOD, and
instructing one or more of the at least one IOD on how to participate in the adaptation of the first set of at least one IOD, based on the determined adaptation.

14-18. (canceled)

19. A method in a first Input/Output Device, IOD, for contributing when adapting connectivity during an ongoing communication session, the method comprising:
receiving, a beacon signal, associated with the ongoing communication session and transmitted by the UT;
determining, based, at least partly, on content of the received beacon signal, indicating whether the received beacon signal is a modified beacon signal or not, if the received beacon signal is to be forwarded to an Input/Output Device Handler, IODH, or refrained from forwarding, and
forwarding, to the IODH, at least part of the content of the received beacon signal, thereby enabling the IODH to determine how the first IOD is to act during the adaptation of the set of at least one IOD, in case it is determined that the received beacon signal is a modified beacon signal and that the at least part of the content is to be forwarded.

20-24. (canceled)

25. A User Tag, UT for enabling adaptation of connectivity of the UT during an ongoing communication session, the UT comprising processing circuitry configured to cause the UT to:
transmit, during the ongoing communication session, a preceding beacon signal, detectable by the at least one IOD when the UT is located in close vicinity of the at least one IOD;
modify the preceding beacon signal, upon determining that an adaptation of the set of at least one IOD is required, wherein the modification comprises including an indication to the beacon signal, indicating a request for an adaptation of the set of at least one IOD, and
transmit the modified beacon signal, thereby enabling one or more IODs, located in close vicinity of the UT, to participate in an adaptation of the set of the at least one IOD.

26. The UT according to claim 25, further configured to transmit the preceding beacon signal, comprising transmission configuration, comprising one or more of:
an indication of the power class applied by the UT when transmitting the preceding beacon signal, and
an indication of a maximum allowed transmission power level applied by the UT when transmitting the preceding beacon signal.

27. The UT according to claim 25, further configured to, during modifying, include the beacon signal with:
a session identity, identifying the ongoing communication session, and
a modification indicator, indicating if an adaptation of the set of at least one IOD is requested or not.

28. The UT according to claim 27, further configured to, during modifying, include the beacon signal with at least one of:
a beacon identifier, indicating that the signal is a beacon signal,
a freshness parameter, being a parameter which is updated each time the beacon signal is transmitted by the UT, thereby distinguishing one transmitted beacon signal from previously transmitted beacon signals,
a cryptographic proof of originator, providing cryptographic protection of at least parts of the beacon signal, and
an indication of capability requirements for the ongoing communication session.

29. The UT according to claim 28, further configured to, during modifying, include the beacon signal with capability requirements, indicating requirement for at least one of:
removing capabilities allocated to the ongoing communication session, which are no longer required by the UT in the ongoing communication session;
adding capabilities to the ongoing communication session, which are required by the UT (100) in the ongoing communication session, and
replacing capabilities allocated to the ongoing communication session with capabilities better suited for the UT in the ongoing communication session than the presently used ones.

30. The UT according to claim 25, further configured to include the modified beacon signal with at least one capability requirement.

31. The UT according to claim 30, further configured to include the modified beacon signal with at least one capability requirement, comprising at least one of: screen, display, speaker, camera, microphone, mouse, keyboard, touchpad, Inertial Measuring Unit (IMU), light source, sensor and actuator.

32. The UT according to claim 25, further configured to modify the beacon signal based on at least one of:
detection that a user interaction, detectable by the UT indicating a request for adaptation of the set of at least one IOD has been executed;
detection that the UT is located in a certain geographical location, requiring an adaptation of the set of at least one IOD;
detection that a certain time instance, requiring an adaptation of the set of at least one IOD has been reached;
detection that a certain time interval, requiring an adaptation of the set of at least one IOD has begun or expired, and
detection that a certain event, detectable by the UT requiring an adaptation of the set of at least one IOD has occurred.

33-36. (canceled)

37. An Input/Output Device Handler, IODH, capable of adapting connectivity of a User Tag, UT, during an ongoing communication session, the IODH comprising processor circuitry configured to cause the IODH to:
receive, from a first set of at least IOD, first information in a respective beacon signal, associated with the ongoing communication session and received by the respective one or more IOD from the UT;
determine an adaptation of the first set of at least one IOD, based on second information comprised in one or more modified beacon signal, received from a second set of at least one IOD, and
instruct one or more of the at least one IOD on how to participate in the adaptation of the first set of at least one IOD, based on the determined adaptation.

38. The IODH according to claim 37, further configured to, at least party, base the determining on signal strength of one or more beacon signal, received by the second set of at least one IOD, and comprised in the received information.

39. The IODH according to claim 37, configured to determine the adaptation based on at least one of the following, comprised in the second information, received from the second set of at least one IOD:
a session identity, identifying the ongoing communication session;
a beacon identifier, indicating that a received signal is a beacon signal;
a freshness parameter, being a parameter which is updated each time a respective beacon signal is transmitted by an IOD thereby distinguishing one transmitted beacon signal from previously transmitted beacon signals;
a cryptographic proof of originator, providing cryptographic protection of at least parts of a beacon signal, and
capability requirements for the ongoing communication session.

40. The IODH according to claim 37, further configured to:
base the adaptation of the first set of at least one IOD, at least partly on a consolidation of said received second information.

41. The IODH of claim 37, configured to further perform the determination, at least partly, based on at least one of the following, comprised in each second information:
signal strength of a beacon signal received by a respective IOD;
battery capacity of a respective IOD;
amount of processing power available in a respective IOD, and
amount of storage capacity available in a respective IOD.

42. (canceled)

43. An Input/Output Device, IOD, capable of contributing when adapting connectivity during an ongoing communication session, the IOD comprising processing circuitry configured to cause toe IOD to:
receive, a beacon signal, associated with the ongoing communication session and transmitted by the UT;
determine, based, at least partly, on content of the received beacon signal, indicating whether the received beacon signal is a modified beacon signal or not, if the received, beacon signal is to be forwarded to an Input/Output Device Handler, IODH, or if the IOD is to refrain from forwarding the modified beacon signal, and
forward, to the IODH, at least part of the content of the received beacon signal, thereby enabling the IODH to determine how the IOD is to act during the adaptation of the set of at least one IOD, in case it is determined that the received beacon signal is a modified beacon signal and that the at least part of the content is to be forwarded.

44. The IOD according to claim 43, further configured to acquire an indication of the signal strength of the beacon signal, when received by the IOD.

45. The IOD according to claim 43, further configured to forward the received beacon signal only in case a filtering criteria for forwarding the received beacon signal is fulfilled.

46. The IOD according to claim 45, wherein the IOD is configured to base the filtering criteria on at least one of:
the signal strength of the received beacon signal;
the battery capacity of the IOD;
capabilities available at the IOD;
the processing power available at the IOD, and
the storage capacity available at the IOD.

47-48. (canceled)
